(19) United States
(12) Patent Application Publication
(10) Pub. No.: US 2024/0151096 A1
(43) Pub. Date: May 9, 2024

(54) SHIM WITH ADJUSTABLE THICKNESS

(71) Applicant: Cemil SAHIN, Alanya (TR)

(72) Inventor: Cemil SAHIN, Alanya (TR)

(21) Appl. No.: 18/568,181

(22) PCT Filed: Jun. 7, 2022
(86) PCT No.: PCT/EP2022/065416

§ 371 Date: Dec. 7, 2023

(30) Foreign Application Priority Data
Jun. 9, 2021 (EP) 21178466.5

(51) Int. Cl. E06B 1/60; E04F 21/00

(52) U.S. Cl. CPC E06B 1/6069; E04F 21/0015

(57) ABSTRACT

The present invention relates to a shim (100) having a thickness that can be adjusted by means of an actuator device. Actuating the actuator device causes a movement of a sliding element (20) inside a housing (10) in a first direction (101). The movement of the sliding element (20) causes a movement of a movable element (30) in a second direction (102), thus increasing the distance between an outer wall (34, 84, 94) of the movable element (34) and a bottom wall (13) of the housing (10), and thus increasing the thickness of the shim (100).

### TECHNICAL FIELD

The present invention relates to a shim, the thickness of which is adjustable by a user.

### PRIOR ART

Document KR20110134578A describes a shim of variable thickness making it possible to control the horizontal of a door frame under construction. In this known device, horizontal plates can be moved away from one another by moving lifting elements away from one another using a screw.

A problem of this known device is that one of the horizontal plates must rest on a flat surface, without which the different parts of the device are disconnected, and it can therefore only be used for an adjustment of vertical thickness.

Document CN102620120A describes an adjustable sizing blocking device. In this device, when sliding elements move closer to a cylinder, they move up a movable element.

Document DE102006012390A1 describes a shim which is adjustable for the installation of doors or windows.

Document WO2020/011846A1 describes a spacer making it possible to adjust a theoretical gap between two components.

### SUMMARY OF THE INVENTION

An aim of the present invention is to provide a shim with adjustable thickness being able to be used to adjust a vertical thickness or a horizontal thickness.

To this end, the invention proposes a shim comprising:
a casing comprising:
   a front wall,
   a rear wall, opposite the front wall in a first direction,
   a bottom wall, and
   an opening, opposite the bottom wall in a second direction perpendicular to the first direction;
   a sliding element located, at least partially, in the casing, and configured to be moved with respect to the casing in the first direction and to be blocked by the casing in a third direction perpendicular to the first direction and to the second direction;
   a movable element configured to pass through the opening, comprising an external wall opposite the bottom wall in the second direction, and configured to be moved in the second direction by the sliding element when the sliding element is moved with respect to the casing in the first direction, and to be blocked by the casing in the third direction; and
   an actuator device making it possible for a user to move the sliding element in the first direction with respect to the casing, so as to move the movable element in the second direction;
characterized in that it comprises a retaining mechanism configured to retain the movable element and the sliding element at least partially in the casing and in a fixed position with respect to the casing, in the absence of actuation of the actuator device, and to enable a movement of the sliding element in the first direction and a movement of the movable element in the second direction during an actuation of the actuator device.

The shim according to the invention operates as follows. The user actuates the actuator device, which moves the sliding element in the first direction. The movement of the sliding element generates a thrust or a traction on the movable element, which is moved in the second direction. Since the movable element passes through the opening, it is thus moved away from or closer to the bottom wall of the casing. Thus, the thickness of the shim, given by the distance between the bottom wall of the casing and the external wall of the movable element, can be adjusted by actuating the actuator device. Thanks to the retaining mechanism, the different elements remain together, without relative movement, before actuating the shim. This makes it possible for the thickness of the shim to be fixed before any actuation.

As the casing prevents movements of the sliding element and of the movable element in the third direction during their respective movements, it is possible to adjust a horizontal thickness by placing the shim such that the third direction is vertical.

In the scope of the present document, the front of the shim is the side of the shim rotated towards the user actuating the actuator device.

The shim can be made so as to be sufficiently light to hold between two vertical surfaces, and sufficient cheap to be single-use.

A shim according to the invention can be proposed in several models of different lengths, as different lengths (in the first direction) make it possible to obtain ranges of different thicknesses (in the second direction).

According to an embodiment of the invention, the sliding element comprises a rear wall which is oblique with respect to the first and second directions, and the movable element comprises a front wall which is oblique with respect to the first and second directions and configured to slide over the rear wall of the sliding element. The skew makes it possible for the back-and-forth movement in the first direction of the sliding element leads to a movement of the movable element in the second direction. The driving of the movable element by the sliding element could be achieved in another way, while remaining in the scope of the invention.

According to an embodiment of the invention, the sliding element and the movable element are blocked against one another in the third direction by a blocking mechanism located on the sliding element and/or the movable element. This makes it possible to reduce the risks of a relative movement of the movable element with respect to the sliding element in the third direction.

According to an embodiment of the invention, the blocking mechanism comprises a projecting plate located on the sliding element and perpendicular to the third direction, and a slot located on the movable element and arranged to receive the plate, at least partially. The slot extends in the first direction, such that the plate can be moved in the slot when the actuator device is actuated. The blocking mechanism could be inverted, with a plate located on the movable element and the slot on the sliding element.

According to an embodiment of the invention, the actuator device comprises a front hole passing through the front wall, and a rod passing into the front hole and having a first end intended to push and/or pull the sliding element and a second end, located outside of the casing, and intended to be actuated by the user. As the second end of the rod projects with respect to the casing, it is easy to adjust the thickness when the shim is in place.

The actuator device can be arranged in another way. It could, for example, comprise a self-blocking mechanism only making it possible to increase the thickness and not decrease it.

According to an embodiment of the invention, the rod comprises a net corresponding to the front hole, and wherein the length of the casing is greater than or equal to the sum of the length of the sliding element and of the length of the net. The difference between the length of the casing (i.e. its inner length) and the length of the sliding element is the maximum amplitude of the movement of the sliding element in the first direction. The fact that this maximum movement amplitude is equal to or greater than the length of the net makes it possible to avoid the user sinking the rod too far into the casing, which could push the sliding element against the rear wall, with a risk of extruding the sliding element outside of the casing or of breaking the shim.

According to an embodiment of the invention, the casing comprises fixing element making it possible to associate the rear wall to a first surface or to a second surface external to the shim. For example, the casing can comprise an adhesive to adhere the rear wall on the outer surface, and/or holes in the rear wall and/or on tabs to screw the rear wall against the first surface.

According to an embodiment of the invention, the entire sliding element moves away from the front wall and moves closer to the rear wall when it is moved by the actuator device. Such a configuration enables a particularly simple and robust architecture of the shim.

According to an embodiment of the invention, the movable element is configured to be blocked by the rear wall of the casing in the third direction. This avoids having to introduce other elements in the shim, which would increase its complexity.

According to an embodiment of the invention, the retaining mechanism comprises a first part located on a first wall and a second wall of the casing and a second part located on the movable element; the first and second walls of the casing being perpendicular to the third direction. This makes it possible to block the movable element to the left and to the right, and therefore to retain it particularly well.

According to an embodiment of the invention, the first part of the retaining mechanism comprise projections located on the first wall and the second wall of the casing, and the second part of the retaining mechanism comprises recesses located on a first wall and a second wall of the movable element, and provided to receive the projections; the first and second walls of the movable element being perpendicular to the third direction; the shim being configured such that the projections are moved away when the movable element is moved by the sliding element. The projections are on the internal face of the first and second walls of the casing. Thus, without actuation, the projections remain in the recesses, but if the actuator is actuated, the movable element is pushed in the third direction and this thrust has the effect of moving the projections away and of enabling the movement. With the sliding element being located between the movable element and the bottom wall of the casing, it is also retained by the interlocking of the projections in the recesses. The projections can, for example, be teeth.

According to an embodiment of the invention, the movable element comprises a main element configured to be moved by the sliding element, and a first removable element configured to be removably fixed to the main element and to increase the thickness of the movable element in the second direction. The external wall of the movable element can thus be a bearing wall of the main element if the removable element is not present, or a bearing wall of the removable element if it is present. The adjustment of thickness can thus be done in two combinable ways: at least one removable element provides a thickness, which can be varied (by omitting the first removable element, by fixing an additional removable element to it and/or by replacing it with a replacement removable element) and the movement of the movable element provides another thickness, which can also be varied (by actuating the actuator device). Preferably, the variation of thickness starting with the movement of the movable element enables a finer adjustment than the variation of thickness starting with the removable element.

According to an embodiment of the invention, the removable fixing between the main element and the first removable element comprises a pin and a mortise. The pin and the mortise extend preferably in the first direction. They are preferably provided for a sliding in the first direction and a blocking in the second and the third direction. This makes it possible to slide the first removable element over the main element, when the casing, the sliding element and the main element are already in the space between the first and second surfaces.

According to an embodiment of the invention, the shim comprises an additional removable element configured to be removably fixed to the first removable element and to increase the thickness of the movable element in the second direction. It is thus possible to superpose removable elements, in order to obtain a large thickness.

The invention is also based on an assembly comprising the shim comprising the main element and the first removable element, and at least one replacement removable element configured to be fixed to the main element instead of the first removable element, the replacement removable element and the first removable element having different thicknesses. The assembly thus comprises a set of at least two removable elements. This makes it possible to give a large interval of possible thicknesses.

The invention is also based on a kit comprising a shim and a holding element comprising two clamps fixed to a rigid rod and configured to hold the two vertical uprights of a door at a fixed distance from one another.

The invention is also based on a method for using a shim, the method comprising the following steps:
placing the shim in a space between a first and a second surface; and
actuating the actuator device until the bottom wall is against the first surface and the external wall is against the second surface.

Preferably, the casing is fixed with respect to the first surface during the actuation of the actuator device. It can, for example, be fixed to the first surface.

The first surface is, for example, on a door, chassis, frame upright, and the second surface, on a wall. The first surface is, for example, any element demanding an accurate and easy mounting.

For a door, the method can be performed for several shims, for example, two shims for each vertical upright, and optionally a shim for the horizontal upright. Thus, the implementation of a door frame can demand using at least four or five shims.

Once the shims are adjusted, such that the vertical uprights are placed vertically and the horizontal upright is placed horizontally, the rods of the actuator rods can be broken or removed, in order to not exceed towards the front of the uprights of the door. A foam can thus be dispensed between the door frame and the wall. The shims will thus be covered in the foam.

The invention is also based on a method for using a shim comprising the main element and the first removable element, the method comprising the following steps:
placing the casing, the sliding element and the main element in a space between a first and a second surface;
fixing the first removable element to the main element; and
actuating the actuator device until the bottom wall is against the first surface and the external wall is against the second surface.

The first removable element can be fixed to the main element, while the casing is also outside of the space between the surfaces, or when the casing is already in the space between the surfaces.

### BRIEF DESCRIPTION OF THE FIGURES

Other features and advantages of the invention will appear upon reading the detailed description below for the understanding of which, the accompanying figures will be referred to, among which:

FIG. 1 illustrates a door frame located in the hole of a wall and fixed to this wall thanks to four shims,

FIG. 2 illustrates a casing,

FIG. 3a illustrates a sliding element,

FIG. 3b is another view of the sliding element,

FIG. 4 illustrates a movable element,

FIG. 5 illustrates a rod,

FIGS. 6a to 6c illustrate a use of a shim according to an embodiment,

FIGS. 7a to 7c illustrate a use of a shim according to another embodiment,

FIG. 8 illustrates a sliding element,

FIG. 9 illustrates a movable element,

FIG. 10 illustrates a main element of a movable element,

FIG. 11 illustrates a removable element,

FIG. 12a illustrates a casing, and

FIG. 12b illustrates a main element.

### EMBODIMENTS OF THE INVENTION

The present invention is described with particular embodiments and references to figures, but the invention is not limited by these. The drawings or figures described are only schematic and are not limiting. Furthermore, the functions described can be achieved by structures other than those described in the present document.

In the context of the present document, the terms “first” and “second” only serve to differentiate the different elements and do not imply any order between these elements.

In the figures, identical or similar elements can have the same references.

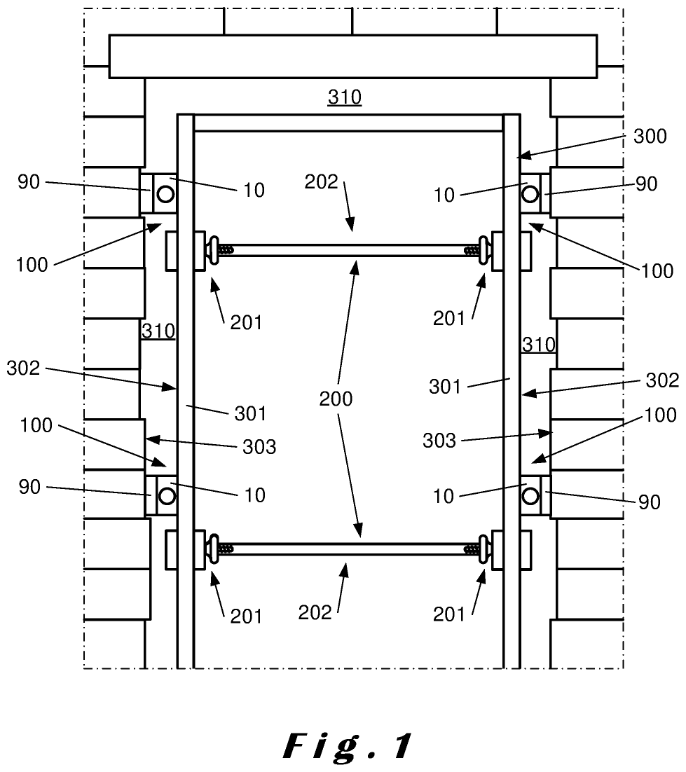

FIG. 1 schematically illustrates a door frame 300 wedged in the hole of a wall by four shims 100. The door frame 300 comprises two vertical uprights 301 and a horizontal upright. The vertical uprights 301 are held at a distance from one another, thanks to two holding elements 200 comprising two clamps or jaws 201 fixed to a rigid rod 202. The shims 100 are located in a space 310 between the door frame 300 and the wall. The shims 100 according to the invention comprise a casing 10, a sliding element 20, a movable element 30, and an actuator device. Possible embodiments of these elements are described in reference to the following figures by making reference to a first 101, a second 102 and a third 103 direction, which are perpendicular to one another. The thickness which is adjustable thanks to the shim 100 is the extent of the shim 100 in the second direction 102.

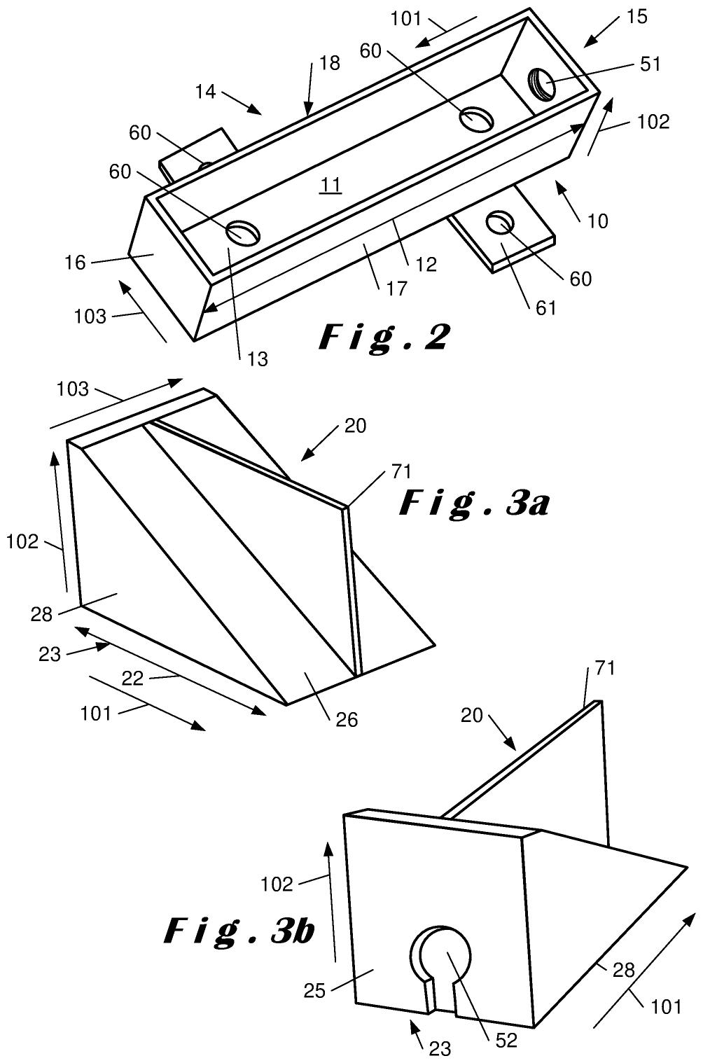

FIG. 2 illustrates a possible embodiment of the casing 10. It preferably comprises a front wall 15 and a rear wall 16 perpendicular to the first direction 101, a bottom wall 13 perpendicular to the second direction 102, an opening 11 in a plane perpendicular to the second direction 102, and a first wall 17 and a second wall 18 perpendicular to the third direction 103. The side 14 of the casing opposite the bottom wall 13 can be present and passed through, through the opening 11, or be absent.

The front wall 15 and the rear wall 16 are spaced apart by a length 12 in the first direction 101. The front wall 15 is passed through by a front hole 51, preferably threaded, forming part of a possible embodiment of the actuator device. The casing 10 can comprise at least one fixing hole 60, located in the bottom wall 13 and/or in the tabs 61. The holes 60 in the tabs 61 are preferred to the holes 60 in the bottom wall 13, as the placement of the latter requires removing the sliding element 20 and the movable element 30.

The length 12 of the casing 10 is preferably between 4 cm and 15 cm. The width of the casing 10 is preferably between 2 cm and 4 cm. The thickness of the casing 10 is preferably between 2 cm and 4 cm.

FIGS. 3a and 3b illustrate a possible embodiment of the sliding element 20. It preferably comprises a front wall 25 perpendicular to the first direction 101, a bottom wall 23 perpendicular to the second direction 102, and a first wall and a second wall 28 perpendicular to the third direction 103. It also comprises a rear wall 26 which is oblique with respect to the first 101 and second 102 directions, such that it has a thickness, in the second direction 102, larger at the front than at the rear.

The sliding element 20 is configured to be, at least partially, in the casing 10, such that its first wall slides in the first direction 101 against the first wall 17 of the casing 10, and is blocked in the third direction 103 by the first wall 17 of the casing 10; such that its second wall 28 slides in the first direction 101 against the second wall 18 of the casing 10 and is blocked in the third direction 103 by the second wall 18 of the casing 10; and such that its bottom wall 23 slides in the first direction 101 against the bottom wall 13 of the casing 10 and is blocked in the second direction 102 by the bottom wall 13 of the casing 10.

The length 22 of the sliding element 20, in the first direction 101, is less than the length 12 of the casing 10. It can preferably slide in the casing between a first position, wherein its front wall 25 is blocked by the front wall 15 of the casing 10, and a second position, wherein the end of its rear wall 26 is blocked by the rear wall 16 of the casing 10.

The thickness of the sliding element 20, in the second direction 102, is preferably equal to or less than the thickness of the casing 10. The width of the sliding element 20, in the third direction 103, is preferably less than or equal to the inner width of the casing 10.

The sliding element 20 can comprise a plate 71, projecting over the rear wall 26. The plate 71 is arranged to be movably engaged in the first direction 101 and the second direction 102, in a slot 72 of the movable element 30, thus forming a blocking mechanism, blocking the sliding element 20 and the movable element 30 in the third direction 103.

The sliding element 20 can comprise a recess 52 aligned with the front hole 51 and forming part of a possible embodiment of the actuator device.

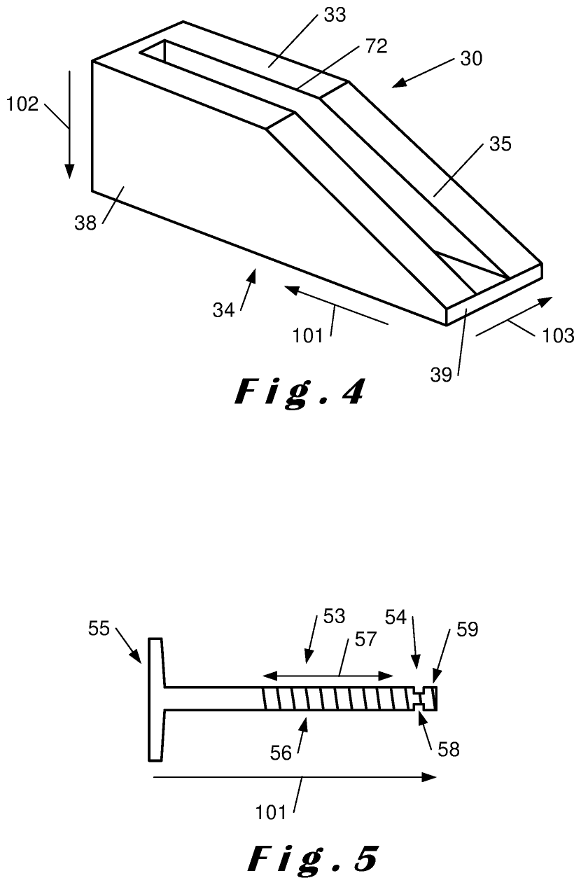

FIG. 4 illustrates a possible embodiment of the movable element 30. It preferably comprises a rear wall 36 (which can be seen in FIG. 9) perpendicular to the first direction 101, a bottom wall 33 perpendicular to the second direction 102, and a first wall 37 (which can be seen in FIG. 9) and a second wall 38 perpendicular to the third direction 103. It also comprises a front wall 35 which is oblique with respect to the first 101 and second 102 directions, such that it has a thickness, in the second direction 102, larger at the rear than at the front. It also comprises a bearing wall 34 opposite the bottom wall 13 of the casing 10 and located outside of the casing 10. It can also comprise an additional wall 39, forming the junction between the front wall 35 and the bearing wall 34. It can also comprise a flat slot 72 extending in the first 101 and the second 102 directions. The length, in the first direction 101, of the bottom wall 33, is preferably smaller than or equal to the movement amplitude of the movable element 20 in the first direction 101.

The movable element 30 is configured to be engaged in the casing 10, such that its first wall slides in the second direction 102 against the first wall 17 of the casing 10, and is blocked in the third direction 103 by the first wall 17 of the casing 10; such that its second wall 38 slides in the second direction 102 against the second wall 18 of the casing 10 and is blocked in the third direction 103 by the second wall 18 of the casing 10; and such that its rear wall 36 slides in the second direction 102 against the rear wall 16 of the casing 10 and is blocked in the first direction 101 by the rear wall 16 of the casing 10.

FIG. 5 illustrates a rod 53 forming part of a possible embodiment of the actuator device. The rod 53 is provided to pass into the hole 51, and such that its net 56 is interlocked in the thread of the hole 51. Its first end 54 is located in the casing 10 and is intended to push and/or pull the sliding element 20. Its second end 55, opposite the first end 54 in the first direction 101, is located on the other side of the front wall 15 and is intended to be actuated by the user.

The first end 54 can, for example, be received in the recess 52 and/or be fixed to the sliding element 20. It preferably comprises a reinforcement 58 followed by an expansion 59 such that the expansion is located in the recess 52 and can pull the sliding element 20 to the front wall 15.

The second end 55 is preferably arranged to be able to be rotated by hand, without a screwdriver, for example, thanks to a T-shape. The second end 55 is preferably arranged to be able to be broken, so as to reduce the length of the shim 100 in the first direction 101.

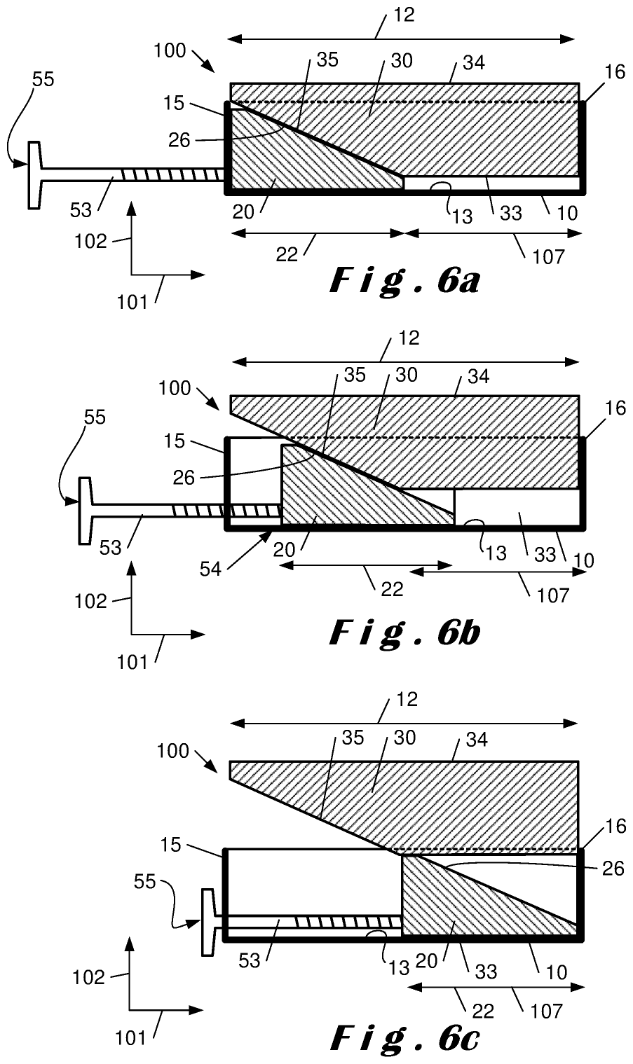

In an embodiment of the invention, the length 57 of the net 56 of the rod 53 is less than or equal to the difference 107 between the length 12 of the casing 10 and the length 22 of the sliding element 20 (which can be seen in FIG. 6a).

FIGS. 6a to 6c illustrate an operating mode of a shim 100 according to an embodiment of the invention. The shim, such as illustrated in FIG. 6a, is placed in a space 310 between a first 302 and a second 303 surface which face one another in the second direction 102, such that the second end 55 of the rod 53 is towards the user. FIGS. 6b and 6c illustrates what happens when the user moves the rod 53 in the first direction 101, from the front to the rear. The first end 54 of the rod 53 pushes the sliding element 20 in the first direction 101, from the front to the rear. The rear wall 26 of the sliding element 20 pushes the front wall 35 of the movable element 30. Regarding the skew of the walls 26, 35, and as the movable element 30 is blocked in the first direction 101 by the rear wall 16 of the casing 10, the front wall 35 of the movable element 30 slides against the rear wall 26 of the sliding element 20, and the movable element 30 is moved in the second direction 102, by moving away from the bottom wall 13. Its bearing wall 34 (or 84 or 94 as described below), which forms its external wall, can thus move closer to the second surface 303. If the user releases the rod 53, the movable element 30 remains in place. If the user moves the rod 53 from the rear to the front, the movable element 30 can move closer to the bottom wall 13 so as to decrease the thickness of the shim 100.

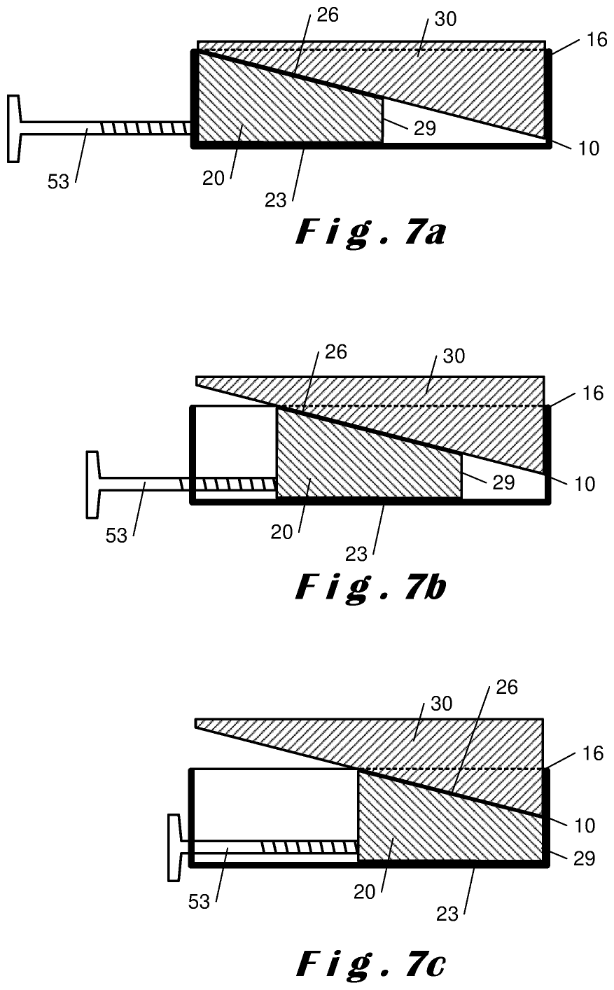

FIGS. 7a to 7c illustrate an operating mode of a shim 100 according to another embodiment of the invention. In this embodiment, the sliding element 20 comprises an additional wall 29, forming the junction between the rear wall 26 and the bottom wall 23 and being able to abut against the rear wall 16 of the casing 10. The additional wall 29 can be perpendicular to the first direction 101. The embodiment of FIGS. 7a to 7c enables a better stability of the shim than the embodiment of FIGS. 6a to 6c, in particular at the maximum position illustrated in FIGS. 6c and 7c. With the slope of the rear wall 26 being lower in the embodiment of FIGS. 7a to 7c than in the embodiment of FIGS. 6a to 6c, the latter enables a greater variability in thickness of the shim 100.

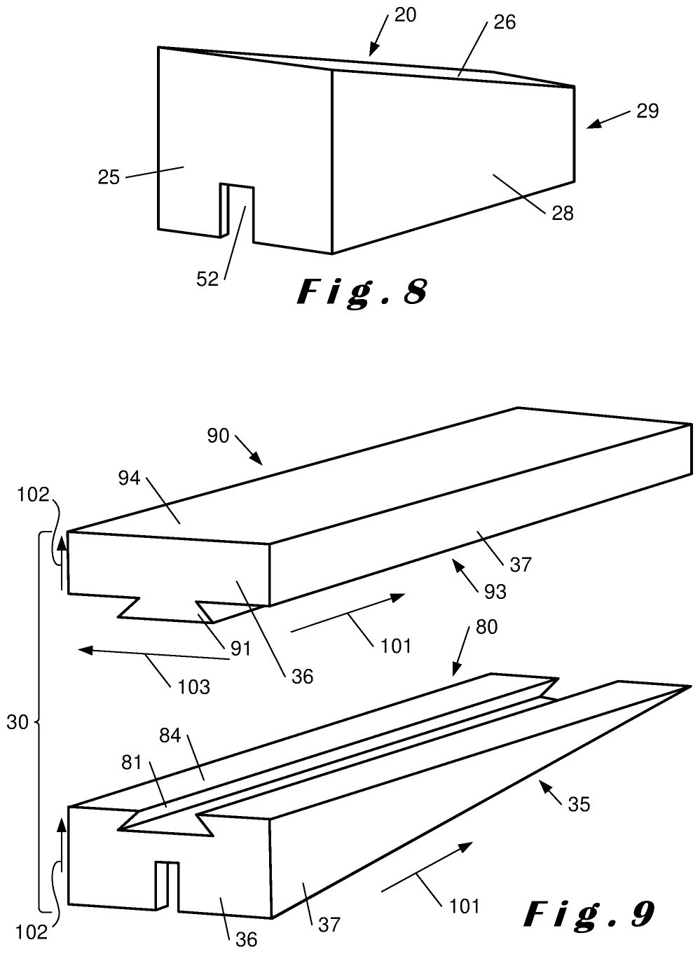

FIG. 8 is another illustration of the sliding element 20 of FIGS. 7a to 7c.

FIG. 9 illustrates another possible embodiment of the movable element 30, wherein the movable element 30 comprises a main element 80 in contact with the sliding element 20, and a first removable element 90 which can be removably fixed to the main element 80. The main element 80 comprises a bearing wall 84, perpendicular to the second direction 102, which forms the external wall of the shim 100, if the first removable element 90 is absent.

The removable element 90 comprises a bearing wall 94, perpendicular to the second direction 102, and which forms the external wall of the shim 100, if the first removable element 90 is present. It also comprises a bottom wall 93 opposite the bearing wall 94 and in contact with the main element 80.

The removable fixing between the main element 80 and the first removable element 90 comprises a mortise 81 and a pin 91, respectively located on the bearing wall 84 of the main element 80 and on the bottom wall 93 of the first removable element 90, or the opposite. The mortise 81 and the pin 91 preferably have a parallelogram shape in a plane perpendicular to the first direction 101.

An assembly according to the invention can comprise several removable elements among which the first removable element and other removable elements being able to be put in its place and having thicknesses, in the second direction 102, which are different.

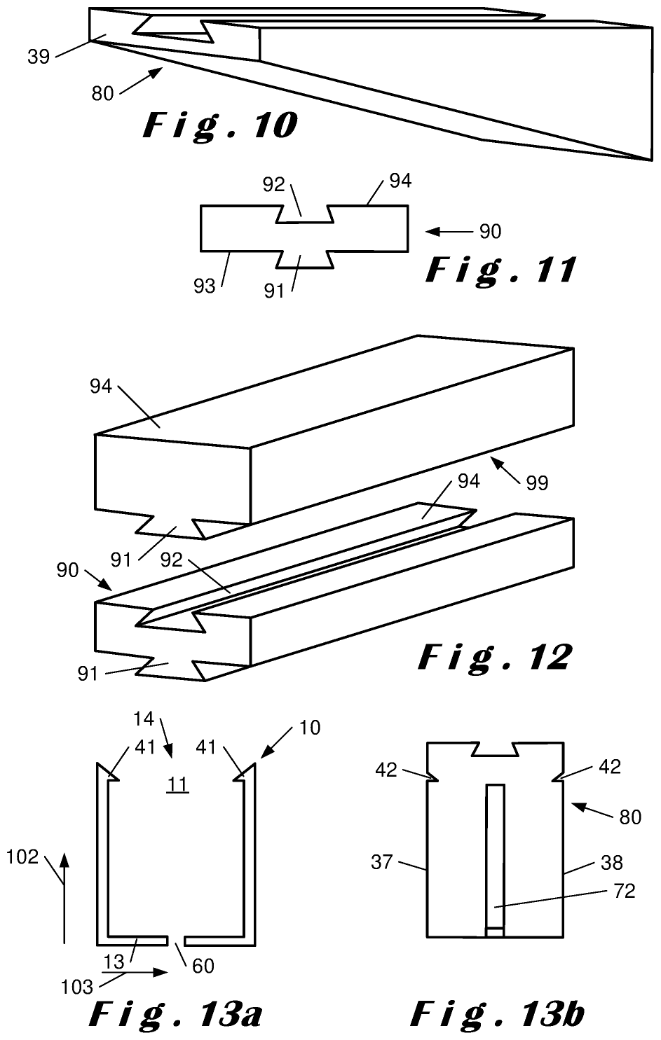

FIG. 10 illustrates a variant of the main element 80. It could, for example, suit the embodiment of the shim 100 illustrated in FIGS. 7a to 7c.

FIGS. 11 and 12 make it possible to illustrate that removable elements can also be provided to be fixed to one another. The first removable element 90 can, for example, be such as illustrated in FIGS. 11 and 12, and comprise a pin 91 on the bottom wall 93 and a mortise 92 on the bearing wall 94. The mortise 92 makes it possible to fix an additional removable element 99. The first removable element 90 and the additional removable element 99 can be of the same thickness or of different thicknesses.

Each removable element preferably has a thickness of between 0.5 cm and 4 cm.

FIGS. 13a and 13b illustrate an example of a casing 10 and the main element 80 in an embodiment of the invention comprising a retaining mechanism. The retaining mechanism makes it possible to fix the movable element 30 and the sliding element 20 to the casing 10 in the absence of actuation of the actuator device, and enables a movement of the sliding element 20 in the first direction 101 and a movement of the movable element 30 in the second direction 102 during an actuation of the actuator device.

The retaining mechanism can, for example, comprise projections 41 on the internal faces of the first 17 and the second 18 walls of the casing 10, and recesses, for example slots 42 in the external faces of the first 37 and the second 38 walls of the movable element 30. Initially, the projections 41 are in the recesses 42, which blocks the movable element 30 in the second direction 102. As the sliding element 20 is located partially between the movable element 30 and the bottom wall 13 in the second direction, it is also blocked. When the actuator device moves the sliding element 20 from the front to the rear, the pressure exerted by the movable element 30 to move away from the bottom wall makes the projections 41 move away, and therefore enables a movement in the second direction 102.

The rod 53 is preferably metallic. The other elements of the shim 100 are preferably made of polymer (for example, PVC), wood and/or metal. The casing 10 can be a folded sheet.

In the example of use illustrated in FIG. 1, the bottom wall of the casings is fixed to the first surface 302, which is the outer surface of the vertical uprights 301, and the external wall 94 of the first removable element 90 is against the second surface 303, which is the surface of the wall. The fixing could be inverted, while remaining in the scope of the invention. The user can place the shims 100, and, in order to adjust the verticality of the vertical uprights, adjust the thicknesses of the shims 100 by replacing the first removable element 90 with a replacement element and/or by adding an additional removable element 99 and/or by actuating the actuator device. Then, they break or they remove the rod 53 and injects foam into the space 310.

A shim could also be placed in the gap between the lintel and the horizontal upright of the door and so as to adjust the horizontality of the horizontal upright.

In other words, the invention relates to a shim 100, the thickness of which can be adjusted using an actuator device. An actuation of the actuator device leads to a movement of a sliding element 20 in a casing 10 and in a first direction 101. The movement of the sliding element 20 leads to a movement, in a second direction 102, of a movable element 30, thus increasing the distance between an external wall 34, 84, 94 of the movable element 34 and a bottom wall 13 of the casing 10, and therefore the thickness of the shim 100.

The present invention has been described in relation to specific embodiments, which have a purely illustrative value, and must not be considered as limiting. Generally, the present invention is not limited to the examples illustrated and/or described above. The use of the verbs “comprise”, “include”, “have”, or any other variant, as well as their conjugations, cannot in any way exclude the presence of elements, other than those mentioned. The use of the indefinite article “a”, “an”, or the definite article “the”, to introduce an element, does not exclude the presence of a plurality of these elements. The reference numbers in the claims do not limit their scope.

1. A shim comprising:
a casing comprising:
a front wall,
a rear wall, opposite the front wall in a first direction,
a bottom wall, and
an opening, opposite the bottom wall in a second direction perpendicular to the first direction;
a sliding element located, at least partially, in the casing, and configured to be moved with respect to the casing in the first direction and to be blocked by the casing in a third direction perpendicular to the first direction and to the second direction;
a movable element configured to pass through the opening, comprising an external wall opposite the bottom wall in the second direction, and configured to be moved in the second direction by the sliding element when the sliding element is moved with respect to the casing in the first direction, and to be blocked by the casing in the third direction; and
an actuator device making it possible for a user to move the sliding element in the first direction with respect to the casing, so as to move the movable element in the second direction;
characterized in that it comprises a retaining mechanism configured to retain the movable element and the sliding element at least partially in the casing and in a fixed position with respect to the casing, in the absence of actuation of the actuator device, and to enable a movement of the sliding element in the first direction and a movement of the movable element in the second direction during an actuation of the actuator device.

2. The shim according to claim 1, wherein the sliding element comprises a rear wall which is oblique with respect to the first and second directions, and wherein the movable element comprises a front wall which is oblique with respect to the first and second directions and configured to slide over the rear wall of the sliding element.

3. The shim according to claim 1, wherein the sliding element and the movable element are blocked against one another in the third direction by a blocking mechanism located on the sliding element and/or the movable element.

4. The shim according to claim 3, wherein the blocking mechanism comprises a projecting plate located on the sliding element and perpendicular to the third direction, and a slot located on the movable element and arranged to receive the plate, at least partially.

5. The shim according to claim 1, wherein the actuator device comprises:
a front hole passing through the front wall, and
a rod passing into the front hole and having a first end intended to push and/or pull the sliding element and a second end, located outside of the casing, and intended to be actuated by the user.

6. The shim according to claim 5, wherein the rod comprises a net corresponding to the front hole, and wherein the length of the casing is greater than or equal to the sum of the length of the sliding element and of the length of the net.

7. The shim according to claim 1, wherein the casing comprises fixing elements making it possible to associate the rear wall to a first surface or to a second surface external to the shim.

8. The shim according to claim 1, wherein the entire sliding element is moved away from the front wall and is moved closer to the rear wall when it is moved by the actuator device.

9. The shim according to claim 1, wherein the movable element is configured to be blocked by the rear wall of the casing in the third direction.

10. The shim according to claim 1, wherein the retaining mechanism comprises:
a first part located on a first wall and a second wall of the casing, and
a second part located on the movable element;
the first and second walls of the casing being perpendicular to the third direction.

11. The shim according to claim 10, wherein
the first part of the retaining mechanism comprises projections located on the first wall and the second wall of the casing, and
the second part of the retaining mechanism comprises recesses located on a first wall and a second wall of the movable element, and provided to receive the projections;
the first and second walls of the movable element being perpendicular to the third direction;
the shim being configured such that the projections move away when the movable element is moved by the sliding element.

12. The shim according to claim 1, wherein the movable element comprises a main element configured to be moved by the sliding element, and a first removable element configured to be removably fixed to the main element and to increase the thickness of the movable element in the second direction.

13. The shim according to claim 12, wherein the removable fixing between the main element and the first removable element comprises a pin and a mortise.

14. The shim according to claim 13, comprising an additional removable element configured to be removably fixed to the first removable element and to increase the thickness of the movable element in the second direction.

15. An assembly comprising:
a shim according to claim 12, and
at least one replacement removable element configured to be fixed to the main element instead of the first removable element, the replacement removable element and the first removable element having different thicknesses.

16. A kit comprising a shim according to claim 1, and a holding element comprising two clamps fixed to a rigid rod and configured to hold the two vertical uprights of a door at a fixed distance from one another.

17. A method for using a shim according to claim 1, comprising the following steps:
placing the shim in a space between a first and a second surface; and
actuating the actuator device until the bottom wall is against the first surface and the external wall is against the second surface.

18. A method for using a shim according to claim 12, comprising the following steps:
placing the casing, the sliding element and the main element in a space between a first and a second surface;
fixing the first removable element to the main element; and
actuating the actuator device until the bottom wall is against the first surface and the external wall is against the second surface.
